(19) United States
(12) Patent Application Publication
(10) Pub. No.: US 2020/0064680 A1
(43) Pub. Date: Feb. 27, 2020

(54) LIQUID CRYSTAL PANEL AND METHOD OF MANUFACTURING THE SAME

(71) Applicants: HKC Corporation Limited, Shenzhen, Guangdong (CN); Chongqing HKC Optoelectronics Technology Co., Ltd., Chongqing (CN)

(72) Inventor: Chung-Kuang CHIEN, Chongqing (CN)

(21) Appl. No.: 16/461,180

(22) PCT Filed: Jul. 3, 2017
(86) PCT No.: PCT/CN2017/091402

§ 371 Date: May 15, 2019

(30) Foreign Application Priority Data
Dec. 29, 2016 (CN) 201611245412.7

(51) Int. Cl. G02F 1/1335; G02F 1/1339; G02F 1/1337

(52) U.S. Cl. CPC G02F 1/133512; G02F 1/13394; G02F 1/1368; G02F 1/1337; G02F 1/133514

(57) ABSTRACT

A liquid crystal panel and a method of manufacturing the liquid crystal panel are provided. The liquid crystal panel includes a color filter substrate having a substrate, a black matrix disposed on the substrate, at least a recess formed on the black matrix, and an alignment layer disposed on the black matrix and covering a bottom surface of the recess. A seal is disposed on the alignment layer in the recess.

### BACKGROUND

### Technology Field

This disclosure relates to a liquid crystal panel and a method of manufacturing the liquid crystal panel.

### Description of Related Art

The liquid crystal display has many advantages, such as the thin body, low power consumption, and no radiation, and is widely applied. Most of the liquid crystal displays available in the market are backlight type liquid crystal displays each including a liquid crystal panel and a backlight module. The working principle of the liquid crystal panel is to place the liquid crystal between two parallel glass substrates, and to apply a driving voltage to the two glass substrates to control the orientation of the liquid crystal, and refract the light emitted from the backlight module to generate an image frame.

The thin-film-transistor liquid crystal display (TFT-LCD) has the properties including the low power consumption, excellent frame quality and higher production yield, and has gradually become the most popular product in the display field. Similarly, the TFT-LCD includes a liquid crystal panel and a backlight module. The liquid crystal panel includes a color filter substrate (CF substrate) and a thin-film-transistor substrate (TFT substrate). The opposite inner sides of the above substrates are configured with transparent electrodes, respectively. A layer of liquid crystal (LC) is interposed between the two substrates. The liquid crystal panel controls the orientation of the liquid crystal through the electric field to change the polarization state of light, and a polarizer is adopted to implement the transmission and obstruction of the light path and thus the displaying objectives.

The existing narrow border technology of the liquid crystal panel makes a seal inevitably stand on an alignment layer. The seal standing on the alignment layer tends to cause the problem of the early collapse before the seal is cured, thereby affecting the formation of the seal.

### SUMMARY

The disclosure is to provide a liquid crystal panel capable of enhancing the process for forming the seal.

In addition, this disclosure further provides a liquid crystal display using the liquid crystal panel.

In addition, this disclosure further provides a method of manufacturing the liquid crystal panel.

This disclosure provides a liquid crystal panel including a color filter substrate, and the color filter substrate includes a substrate, a black matrix, at least a recess and an alignment layer. The black matrix is disposed on the substrate, the recess is disposed on the black matrix, and the alignment layer is disposed on the black matrix. The alignment layer covers a bottom surface of the recess, and a seal is disposed on the alignment layer in the recess.

In one embodiment, the recess penetrates through the black matrix, and the bottom surface of the recess is the substrate. This configuration makes the production process easier so as to benefit to the manufacturing.

In one embodiment, the seal is a black seal. Since forming the recess on the black matrix will cause light leakage, the configuration of the black seal can prevent the undesired light leakage.

In one embodiment, the recess is a blind recess. Accordingly, the additional light shielding design is not need, so that the process can be simplified.

In one embodiment, the recess continuously surrounds a seal covering region. The process for forming the recess is simple and the connecting effect is good.

In one embodiment, the recess is discontinuously disposed along the seal covering region.

In one embodiment, a width of the recess is smaller than a width of the seal. This configuration can maintain the function of the seal and limit the width of the seal, thereby enhancing the process ability of the line width of the seal.

In one embodiment, the liquid crystal panel further includes a backlight module, and an array substrate is disposed on the backlight module. The array substrate and the color filter substrate are disposed opposite to each other, and the color filter substrate is connected to the array substrate through the seal. A color filter layer staggered with the black matrix is further disposed on the color filter substrate. A liquid crystal and a photo spacer (PS) are disposed between the array substrate and the color filter substrate. A thin film transistor is disposed on the array substrate. The color filter layer, the liquid crystal, the PS and the thin film transistor are disposed within the seal.

In addition, the disclosure further provides an LCD device including any of the above-mentioned liquid crystal panel.

In addition, the disclosure further provides a method of manufacturing a liquid crystal panel, which forms the above-mentioned recess on the black matrix by a half tone mask process.

The black matrix is formed with a recess corresponding to a position of the seal, the alignment layer covers the bottom surface of the recess, and the seal is disposed on the alignment layer. In the conventional design, the seal tends to have the early collapse before being cured due to the larger contact angle on the alignment layer. The gap provided by the recess inhibits the collapse range of the seal on the alignment layer so that the process variation caused by the contact angle can be converged and the process ability of the line width of the seal can be enhanced. This is particularly suitable for the narrow border liquid crystal panel.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1a is a schematic contact view showing the uncured seal on the glass;

FIG. 1b is a schematic contact view showing the uncured seal on the black matrix;

FIG. 1c is a schematic contact view showing the uncured seal on the alignment layer;

FIG. 2a is a schematic view showing an ordinary seal;

FIG. 2b is a schematic view showing a black seal;

FIG. 3 is a partial schematic view showing a liquid crystal panel according to an embodiment of this disclosure;

FIG. 4 is a partial schematic structure view showing a color filter substrate according to the embodiment of this disclosure;

FIG. 5 is a schematic view showing the recess and the seal on the black matrix according to the embodiment of this disclosure;

FIG. 6 is a schematic view showing the recess on the black matrix according to the embodiment of this disclosure;

FIG. 7 is another schematic view showing the recess on the black matrix according to the embodiment of this disclosure;

FIG. 8 is another schematic view showing the partial structure of the color filter substrate according to the embodiment of this disclosure.

FIG. 9 is a schematic view showing a method of manufacturing the liquid crystal panel according to the embodiment of this disclosure.

### DETAILED DESCRIPTION OF THE DISCLOSURE

Specific structures and function details disclosed herein are only for the illustrative purpose for describing the exemplary embodiment of this disclosure. However, this disclosure can be specifically implemented through many replacements, and should not be explained as being restricted to only the embodiment disclosed herein.

In the description of this disclosure, it is to be understood that the terms “center”, “transversal”, “up,” “down,” “left,” “right,” “vertical”, “horizontal”, “top,” “bottom,” “inside” and “outside” indicating the orientation or position relationships are the orientation or position relationships based on the drawing, are only provided for the purposes of describing this disclosure and simplifying the description, but do not indicate or imply that the directed devices or elements must have the specific orientations or be constructed and operated in the specific orientations, and thus cannot be understood as the restriction to this disclosure. In addition, the terms “first,” and “second” are used for the illustrative purpose only and cannot be understood as indicating or implying the relative importance or implicitly specifying the number of indicated technical features. Therefore, the features restricted by “first” and “second” may expressly or implicitly comprise one or multiple ones of the features. In the description of this disclosure, unless otherwise described, the meaning of “multiple” comprises two or more than two. In addition, the terms “comprises” and any modification thereof intend to cover the non-exclusive inclusions.

In the description of this disclosure, it needs to be described that, unless otherwise expressly stated and limited, the terms “mount,” “link” and “connect” should be broadly understood. For example, they may be the fixed connection, may be the detachable connection or may be the integral connection; may be the mechanical connection or may also be the electrical connection; or may be the direct connection, may be the indirect connection through a middle medium or may be the inner communication between two elements. It will be apparent to those skilled in the art that the specific meanings of the above terms in this application may be understood according to the specific conditions.

The terms used herein are for the purpose of describing only specific embodiments and are not intended to limit the exemplary embodiments. Unless the contexts clearly indicate otherwise, the singular form “one,” “a” and “an” used here further intend to include plural forms. It should also be understood that the terms “comprising” and/or “including” are used herein to describe the features to describe the presence of stated features, integers, steps, operations, units and/or elements without excluding the presence or addition of one or more other features, integers, steps, operations, units, elements, and/or combinations thereof.

This disclosure will be described in detail according to the preferred embodiment with reference to the drawings.

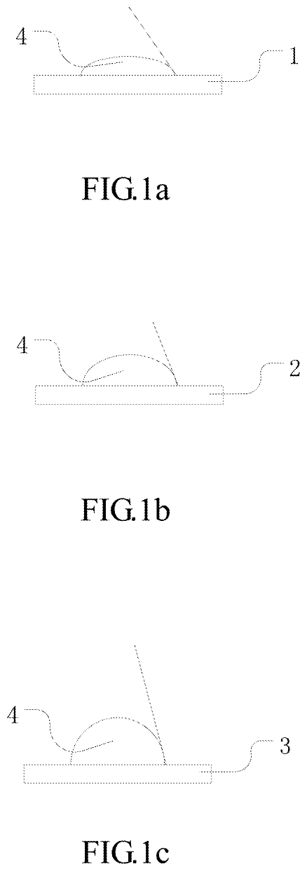

As shown in FIGS. 1a to 1c, the technology of the narrow border of the liquid crystal panel makes the seal inevitably stand on the alignment layer. Because the uncured seal (or sealant) stands on the glass substrate, the black matrix and the alignment layer have different contact angles, the seal stands on the substrate at the minimum contact angle, the seal stands on the black matrix at the moderate contact angle, and the seal stands on the substrate at the maximum contact angle. It is obtained that the seal standing on the alignment layer tends to encounter the problem of early collapse before being cured, and that the process ability of the frame degree of the seal is affected.

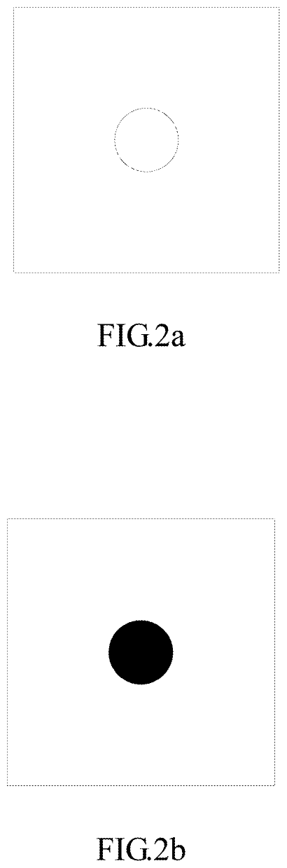

As shown in FIGS. 2a and 2b, two heat auxiliary curable materials are applied, wherein FIG. 2a represents the transparent seal, and FIG. 2b represents the black seal. Compared with the ordinary transparent seal, the black seal has the light-obstructing effect, wherein the black seal has the optical density OD 5 um/2.5, and the BM has the optical density OD ranging from about 4 to 5.

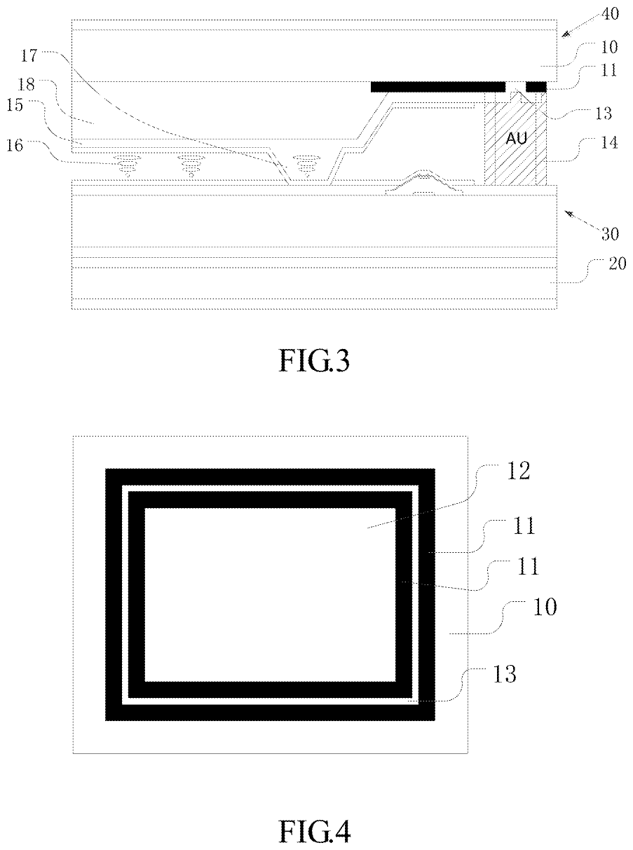

In the embodiment shown in FIG. 3, a liquid crystal panel comprises an array substrate 30 and a color filter substrate 40. The array substrate 30 and the color filter substrate 40 are disposed opposite to each other. The color filter substrate 40 is connected to the array substrate 30 through the seal 14. A color filter layer 18 staggered with a black matrix 11 is also disposed on the color filter substrate 40. A liquid crystal 16 and a photo spacer (PS) 17 are provided between the array substrate 30 and the color filter substrate 40. A thin film transistor or transistors are disposed on the array substrate 30. The color filter layer 18, the liquid crystal 16, the PS 17 and the thin film transistor are disposed within the seal 14. Of course, the liquid crystal panel may also comprise a backlight module 20, the array substrate 30 is disposed on a back cover module 19, and the array substrate 30 and the color filter substrate 40 are disposed opposite to each other. A substrate 1 may be made of the glass material, the plastic material or the like.

In the embodiment shown in FIGS. 4 and 5, a color filter substrate comprises the substrate 10, the black matrix 11, an alignment layer 15 and at least a recess 13. The black matrix 11 is disposed on the substrate 10, the recess 13 is formed on the black matrix 11, the alignment layer 15 is disposed on the black matrix 11, the alignment layer 15 covers a bottom surface of the recess 13, and the seal 14 is disposed on the alignment layer 15 in the recess 13.

The black matrix 11 is formed with the recess 13 corresponding to a position of the seal 14, the alignment layer 15 covers the bottom surface of the recess 13, the seal 14 is disposed on the alignment layer 15, and the seal 14 tends to have the early collapse before being cured due to the larger contact angle on the alignment layer 15. The step of the recess 13 inhibits the collapse range of the seal 14 on the alignment layer 15 so that the process variation caused by the contact angle can be converged and the process ability of the line width of the seal 14 can be enhanced. This is particularly suitable for the narrow border liquid crystal panel.

In the normal condition, the ultra-violet ray lamp (UV lamp) for illuminating the side of the color filter substrate (CF) is obstructed by the black matrix 11 (BM). At present, a recess is formed on the black matrix 11 (BM) of the color filter substrate (CF) to avoid the problem, to solve the problem that the shadow portion is not sufficiently cured, and further to decrease the process restriction. The UV curing of the seal may be illuminated from the array substrate 30 on the TFT side, and may also be illuminated from the color filter substrate (CF) side, wherein the narrow border curing is made by the illumination on the CF side, and the problem that the shadow portion is not sufficiently cured can be reduced.

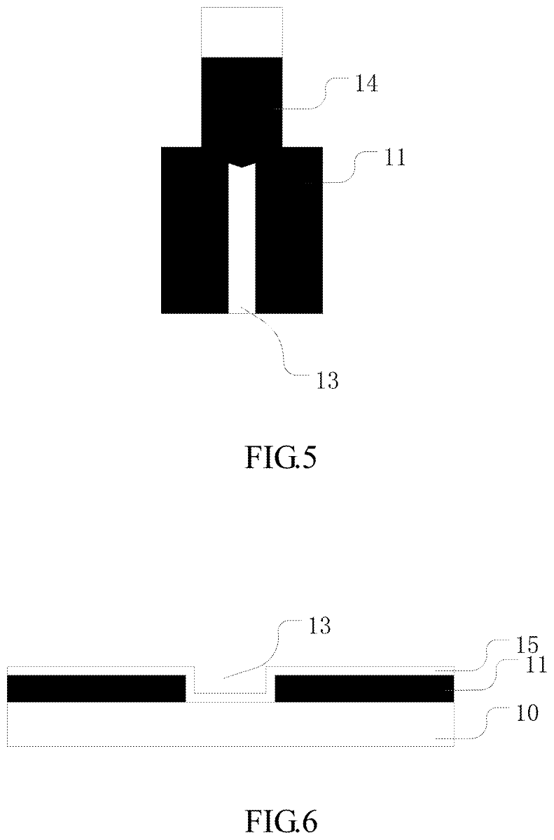

In the embodiment shown in FIGS. 3 to 6, the liquid crystal panel comprises the array substrate 30 and the color filter substrate 40. The array substrate 30 and the color filter substrate 40 are disposed opposite to each other. The color filter substrate 40 is connected to the array substrate 30 through the seal 14. The color filter layer 18 staggered with the black matrix 11 is also disposed on the color filter substrate 40. The liquid crystal 16 and the photo spacer (PS) are provided between the array substrate 30 and the color filter substrate 40. The thin film transistor or transistors are disposed on the array substrate 30. The color filter layer 18, the liquid crystal 16, the photo spacer (PS) and the thin film transistor are disposed within the seal 14. Of course, the liquid crystal panel may also comprise the backlight module 20, the array substrate 30 is disposed on the back cover module 19, and the array substrate 30 and the color filter substrate 40 are disposed opposite to each other. The substrate 10 may be made of the glass material, the plastic material or the like.

The color filter substrate of this embodiment specifically comprises the substrate 10, the black matrix 11, the alignment layer 15 and the recess 13. The black matrix 11 is disposed on the substrate 10, the recess 13 is formed on the black matrix 11, the alignment layer 15 is disposed on the black matrix 11, the alignment layer 15 covers the bottom surface of the recess 13, and the seal 14 is disposed on the alignment layer 15 in the recess 13.

The recess 13 is a through recess penetrating through the black matrix 11 and the bottom surface of the recess 13 is the substrate 10. Production and processing are simple and convenient, and the production can be conveniently implemented. The seal 14 is a black seal. Since the recess 13 formed on the black matrix 11 causes light leakage, the black seal is used and coated to prevent the light leakage.

The recess 13 continuously surrounds the covering region of the seal 14. The recess 13 can be easily processed and has a good connection effect. The width of the recess 13 is smaller than that of the seal 14. The width of the seal 14 is limited without affecting the original function of the seal 14, and the process ability of the line width of the seal 14 can be enhanced.

The black matrix 11 is formed with the recess 13 corresponding to a position of the seal 14, the alignment layer 15 covers the bottom surface of the recess 13, the seal 14 is disposed on the alignment layer 15, and the seal 14 tends to have the early collapse before being cured due to the larger contact angle on the alignment layer 15. The step of the recess 13 inhibits the collapse range of the seal 14 on the alignment layer 15 so that the process variation caused by the contact angle can be converged and the process ability of the line width of the seal 14 can be enhanced. This is particularly suitable for the narrow border liquid crystal panel. In the normal condition, the ultra-violet ray lamp (UV lamp) for illuminating the side of the color filter substrate (CF) is obstructed by the black matrix 11 (BM). At present, a recess is formed on the black matrix 11 (BM) of the color filter substrate (CF) to avoid the problem, to solve the problem that the shadow portion is not sufficiently cured, and further to decrease the process restriction. The UV curing of the seal may be illuminated from the array substrate 30 on the TFT side, and may also be illuminated from the color filter substrate (CF) side, wherein the narrow border curing is made by the illumination on the CF side, and the problem that the shadow portion is not sufficiently cured can be reduced.

In addition to the original properties of the seal, the black seal further has the transmittance thereof to achieve the light-obstructing effect. It is preferred to achieve the same light-obstructing effect as the black matrix, and the shadow portion curing property of the black seal is consistent with or close to the general glue. The process and jig for the liquid crystal panel are adjusted according to the black seal to satisfy various parameter indicators of the liquid crystal panel.

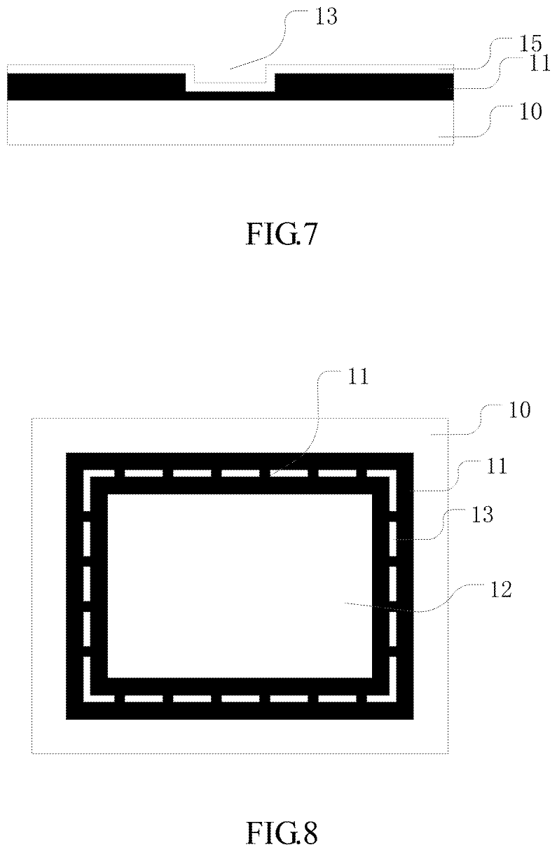

In the embodiment shown in FIGS. 3 to 5 and 7, the liquid crystal panel comprises the array substrate 30 and the color filter substrate 40. The array substrate 30 and the color filter substrate 40 are disposed opposite to each other. The color filter substrate 40 is connected to the array substrate 30 through the seal 14. The color filter layer 18 staggered with the black matrix 11 is also disposed on the color filter substrate 40. The liquid crystal 16 and the photo spacer (PS) are provided between the array substrate 30 and the color filter substrate 40. The thin film transistor or transistors are disposed on the array substrate 30. The color filter layer 18, the liquid crystal 16, the photo spacer (PS) and the thin film transistor are disposed within the seal 14. Of course, the liquid crystal panel may also comprise the backlight module 20, the array substrate 30 is disposed on the back cover module 19, and the array substrate 30 and the color filter substrate 40 are disposed opposite to each other. The substrate 10 may be made of the glass material, the plastic material or the like.

The color filter substrate of this embodiment specifically comprises the substrate 10, the black matrix 11, the alignment layer 15 and the recess 13. The black matrix 11 is disposed on the substrate 10, the recess 13 is formed on the black matrix 11, the alignment layer 15 is disposed on the black matrix 11, the alignment layer 15 covers the bottom surface of the recess 13, and the seal 14 is disposed on the alignment layer 15 in the recess 13.

The recess 13 is a blind recess. Since the recess 13 formed on the black matrix 11 is the blind recess, no additional light-obstructing operation is required, so that the workload is reduced and the light-obstructing effect is not affected.

The recess 13 continuously surrounds the covering region of the seal 14. The width of the recess 13 is smaller than that of the seal 14. The width of the seal 14 is limited without affecting the original function of the seal 14, and the process ability of the line width of the seal 14 can be enhanced.

The black matrix 11 is formed with the recess 13 corresponding to a position of the seal 14, the alignment layer 15 covers the bottom surface of the recess 13, the seal 14 is disposed on the alignment layer 15, and the seal 14 tends to have the early collapse before being cured due to the larger contact angle on the alignment layer 15. The step of the recess 13 inhibits the collapse range of the seal 14 on the alignment layer 15 so that the process variation caused by the contact angle can be converged and the process ability of the line width of the seal 14 can be enhanced. This is particularly suitable for the narrow border liquid crystal panel. In the normal condition, the ultra-violet ray lamp (UV lamp) for illuminating the side of the color filter substrate (CF) is obstructed by the black matrix 11 (BM). At present, a recess is formed on the black matrix 11 (BM) of the color filter substrate (CF) to avoid the problem, to solve the problem that the shadow portion is not sufficiently cured, and further to decrease the process restriction. The UV curing of the seal may be illuminated from the array substrate 30 on the TFT side, and may also be illuminated from the color filter substrate (CF) side, wherein the narrow border curing is made by the illumination on the CF side, and the problem that the shadow portion is not sufficiently cured can be reduced.

In the embodiment shown in FIGS. 3, 5 to 8, the liquid crystal panel comprises the array substrate 30 and the color filter substrate 40. The array substrate 30 and the color filter substrate 40 are disposed opposite to each other. The color filter substrate 40 is connected to the array substrate 30 through the seal 14. The color filter layer 18 staggered with the black matrix 11 is also disposed on the color filter substrate 40. The liquid crystal 16 and the photo spacer (PS) are provided between the array substrate 30 and the color filter substrate 40. The thin film transistor or transistors are disposed on the array substrate 30. The color filter layer 18, the liquid crystal 16, the photo spacer (PS) and the thin film transistor are disposed within the seal 14. Of course, the liquid crystal panel may also comprise the backlight module 20, the array substrate 30 is disposed on the back cover module 19, and the array substrate 30 and the color filter substrate 40 are disposed opposite to each other. The substrate 1 may be made of the glass material, the plastic material or the like.

The color filter substrate of this embodiment specifically comprises the substrate 10, the black matrix 11, the alignment layer 15 and the recess 13. The black matrix 11 is disposed on the substrate 10, the recess 13 is formed on the black matrix 11, the alignment layer 15 is disposed on the black matrix 11, the alignment layer 15 covers the bottom surface of the recess 13, and the seal 14 is disposed on the alignment layer 15 in the recess 13.

The recess 13 is a through recess penetrating through the black matrix 11 and the bottom surface of the recess 13 is the substrate 10. Production and processing are simple and convenient, and the production can be conveniently implemented. The seal 14 is the black seal. Since the recess 13 formed on the black matrix 11 causes light leakage, the black seal is used and coated to prevent the light leakage. Of course, the recess 13 may also be a blind recess. Since the recess 13 formed on the black matrix 11 is a blind recess, no additional light-obstructing operation is required, the workload is reduced and the light-obstructing effect is not affected.

The recess 13 is discontinuously disposed along the covering region of the seal 14.

The width of the recess 13 is smaller than that of the seal 14. The width of the seal 14 is limited without affecting the original function of the seal 14, and the process ability of the line width of the seal 14 can be enhanced.

The black matrix 11 is formed with the recess 13 corresponding to a position of the seal 14, the alignment layer 15 covers the bottom surface of the recess 13, the seal 14 is disposed on the alignment layer 15, and the seal 14 tends to have the early collapse before being cured due to the larger contact angle on the alignment layer 15. The step of the recess 13 inhibits the collapse range of the seal 14 on the alignment layer 15 so that the process variation caused by the contact angle can be converged and the process ability of the line width of the seal 14 can be enhanced. This is particularly suitable for the narrow border liquid crystal panel. In the normal condition, the ultra-violet ray lamp (UV lamp) for illuminating the side of the color filter substrate (CF) is obstructed by the black matrix 11 (BM). At present, a recess is formed on the black matrix 11 (BM) of the color filter substrate (CF) to avoid the problem, to solve the problem that the shadow portion is not sufficiently cured, and further to decrease the process restriction. The UV curing of the seal may be illuminated from the array substrate 30 on the TFT side, and may also be illuminated from the color filter substrate (CF) side, wherein the narrow border curing is made by the illumination on the CF side, and the problem that the shadow portion is not sufficiently cured can be reduced.

In addition to the original properties of the seal, the black seal further has the transmittance thereof to achieve the light-obstructing effect. It is preferred to achieve the same light-obstructing effect as the black matrix, and the shadow portion curing property of the black seal is consistent with or close to the general glue. The process and jig for the liquid crystal panel are adjusted according to the black seal to satisfy various parameter indicators of the liquid crystal panel.

As another embodiment of this disclosure, this embodiment provides a liquid crystal display. The liquid crystal display comprises a housing. The backlight module, the liquid crystal panel and a control circuit board are provided inside the housing. The backlight module provides a light source, the control circuit board provides a display signal to the liquid crystal panel, and the liquid crystal panel is the liquid crystal panel of the above-mentioned embodiment. The specific structure and connection relationship of the liquid crystal panel can be seen in FIGS. 3 to 8, and will not be described in detail.

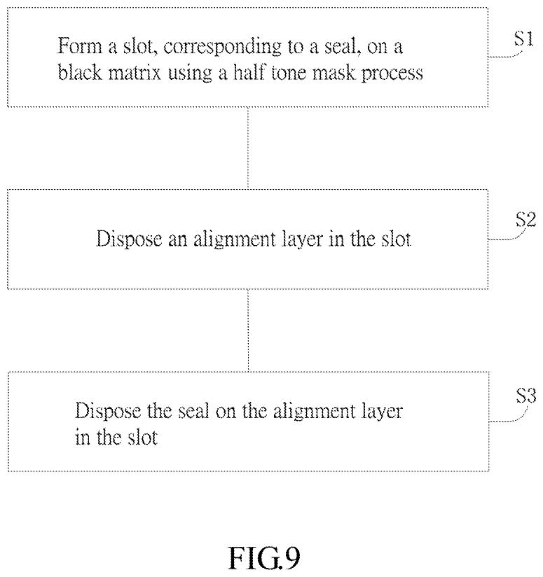

In the embodiment shown in FIG. 9, a method of manufacturing the liquid crystal panel is provided. The method comprises the formation of the recess of the above-mentioned embodiment on the black matrix using the half tone mask process.

The method specifically comprises the following steps.

In step S1, the half tone mask process is performed to form the recess, corresponding to the seal, on the black matrix.

In step S2, the alignment layer is disposed in the recess.

In step S3, the seal is disposed on the alignment layer in the recess.

The black matrix is formed with the recess corresponding to a position of the seal, the alignment layer covers the bottom surface of the recess, the seal is disposed on the alignment layer, and the seal tends to have the early collapse before being cured due to the larger contact angle on the alignment layer. The step of the recess inhibits the collapse range of the seal on the alignment layer so that the process variation caused by the contact angle can be converged and the process ability of the line width of the seal can be enhanced. This is particularly suitable for the narrow border liquid crystal panel. In the normal condition, the ultra-violet ray lamp (UV lamp) for illuminating the side of the color filter substrate (CF) is obstructed by the black matrix 11 (BM). At present, a recess is formed on the black matrix 11 (BM) of the color filter substrate (CF) to avoid the problem, to solve the problem that the shadow portion is not sufficiently cured, and further to decrease the process restriction. The UV curing of the seal may be illuminated from the array substrate 30 on the TFT side, and may also be illuminated from the color filter substrate (CF) side, wherein the narrow border curing is made by the illumination on the CF side, and the problem that the shadow portion is not sufficiently cured can be reduced.

The half tone mask process may be adopted to form the blind recess on the black matrix or the through recess. The recess is a through recess penetrating through the black matrix, and the bottom surface of the recess is the substrate. Production and processing are simple and convenient, and the production can be conveniently implemented. The seal is a black seal. Since the recess is formed on the black matrix to cause light leakage, the black seal is used and coated to prevent the light leakage. The recess is a blind recess. Since the recess 13 formed on the black matrix 11 is the blind recess, no additional light-obstructing operation is required, the workload is reduced and the light-obstructing effect is not affected.

The half tone mask process is adopted to form the continuously surrounding recess on the black matrix along the seal covering region. Of course, a discontinuous recess may also be formed along the seal covering region.

In the above-mentioned embodiment, the color filter substrate may comprise the TFT array, and the color filter and the TFT array may be formed on the same substrate.

In the above-mentioned embodiment, the liquid crystal panel of this disclosure may be a curved panel.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A liquid crystal panel comprising a color filter substrate, the color filter substrate comprising:
a substrate;
a black matrix disposed on the substrate;
at least a recess formed on the black matrix; and
an alignment layer disposed on the black matrix and covering a bottom surface of the recess, wherein a seal is disposed on the alignment layer in the recess;
wherein the recess penetrates through the black matrix, the bottom surface of the recess is the substrate, the seal is a black seal; or the recess is a blind recess;
wherein the recess continuously surrounds a seal covering region; or the recess is discontinuously disposed along the seal covering region; and
wherein a width of the recess is smaller than a width of the seal; the liquid crystal panel further comprises a backlight module, wherein an array substrate is disposed on the backlight module, the array substrate and the color filter substrate are disposed opposite to each other, the color filter substrate is connected to the array substrate through the seal, a color filter layer staggered with the black matrix is further disposed on the color filter substrate, a liquid crystal and a photo spacer are disposed between the array substrate and the color filter substrate, a thin film transistor is disposed on the array substrate, and the color filter layer, the liquid crystal, the PS and the thin film transistor are disposed within the seal.

2. A liquid crystal panel comprising a color filter substrate, the color filter substrate comprising:
a substrate;
a black matrix disposed on the substrate;
at least a recess disposed on the black matrix; and
an alignment layer disposed on the black matrix and covering a bottom surface of the recess, wherein a seal is disposed on the alignment layer in the recess.

3. The liquid crystal panel according to claim 2, wherein the recess penetrates through the black matrix, and the bottom surface of the recess is the substrate.

4. The liquid crystal panel according to claim 3, wherein the seal is a black seal.

5. The liquid crystal panel according to claim 2, wherein the recess penetrates through the black matrix, the bottom surface of the recess is the substrate, and the seal is a black seal.

6. The liquid crystal panel according to claim 2, wherein the recess is a blind recess.

7. The liquid crystal panel according to claim 2, wherein the recess continuously surrounds a seal covering region.

8. The liquid crystal panel according to claim 2, wherein the recess penetrates through the black matrix, the bottom surface of the recess is the substrate, the seal is a black seal, and the recess continuously surrounds a seal covering region.

9. The liquid crystal panel according to claim 2, wherein the recess is a blind recess, and the recess continuously surrounds a seal covering region.

10. The liquid crystal panel according to claim 2, wherein the recess is discontinuously disposed along a seal covering region.

11. The liquid crystal panel according to claim 2, wherein the recess penetrates through the black matrix, the bottom surface of the recess is the substrate, the seal is a black seal, and the recess is discontinuously disposed along a seal covering region.

12. The liquid crystal panel according to claim 2, wherein the recess is a blind recess, and the recess is discontinuously disposed along a seal covering region.

13. The liquid crystal panel according to claim 2, wherein a width of the recess is smaller than a width of the seal.

14. The liquid crystal panel according to claim 2, wherein the recess penetrates through the black matrix, the bottom surface of the recess is the substrate, the seal is a black seal, and a width of the recess is smaller than a width of the seal.

15. The liquid crystal panel according to claim 2, wherein the recess is a blind recess, and a width of the recess is smaller than a width of the seal.

16. The liquid crystal panel according to claim 2, wherein the liquid crystal panel further comprises a backlight module, an array substrate is disposed on the backlight module, the array substrate and the color filter substrate are disposed opposite to each other, the color filter substrate is connected to the array substrate through the seal, a color filter layer staggered with the black matrix is further disposed on the color filter substrate, a liquid crystal and a photo spacer (PS) are disposed between the array substrate and the color filter substrate, a thin film transistor is disposed on the array substrate, and the color filter layer, the liquid crystal, the PS and the thin film transistor are disposed within the seal.

17. The liquid crystal panel according to claim 2, wherein the recess penetrates through the black matrix, the bottom surface of the recess is the substrate, and the seal is a black seal; or the recess is a blind recess; and
wherein a width of the recess is smaller than a width of the seal; the liquid crystal panel further comprises a backlight module, an array substrate is disposed on the backlight module, the array substrate and the color filter substrate are disposed opposite to each other, the color filter substrate is connected to the array substrate through the seal, a color filter layer staggered with the black matrix is further disposed on the color filter substrate, a liquid crystal and a photo spacer (PS) are disposed between the array substrate and the color filter substrate, a thin film transistor is disposed on the array substrate, and the color filter layer, the liquid crystal, the PS and the thin film transistor are disposed within the seal.

18. The liquid crystal panel according to claim 2, wherein the recess penetrates through the black matrix, the bottom surface of the recess is the substrate, and the seal is a black seal; or the recess is a blind recess;
wherein the recess continuously surrounds a seal covering region; or the recess is discontinuously disposed along the seal covering region; and
wherein a width of the recess is smaller than a width of the seal; the liquid crystal panel further comprises a backlight module, an array substrate is disposed on the backlight module, the array substrate and the color filter substrate are disposed opposite to each other, the color filter substrate is connected to the array substrate through the seal, a color filter layer staggered with the black matrix is further disposed on the color filter substrate, a liquid crystal and a photo spacer (PS) are disposed between the array substrate and the color filter substrate, a thin film transistor is disposed on the array substrate, and the color filter layer, the liquid crystal, the PS and the thin film transistor are disposed within the seal.

19. A method of manufacturing a liquid crystal panel, comprising:
providing a substrate;
disposing a black matrix on the substrate;
forming at least a recess on the black matrix by a half tone mask process;
disposing an alignment layer on the black matrix, the alignment layer covering a bottom surface of the recess; and
disposing a seal on the alignment layer in the recess.

20. The method of manufacturing the liquid crystal panel according to claim 19,
wherein the recess penetrates through the black matrix, the bottom surface of the recess is the substrate, and the seal is a black seal; or the recess is a blind recess;
wherein the recess continuously surrounds a seal covering region; or the recess is discontinuously disposed along the seal covering region;
wherein a width of the recess is smaller than a width of the seal; the liquid crystal panel also comprises a backlight module, an array substrate is disposed on the backlight module, the array substrate and a color filter substrate are disposed opposite to each other, the color filter substrate is connected to the array substrate through the seal, a color filter layer staggered with the black matrix is also disposed on the color filter substrate, a liquid crystal and a photo spacer (PS) are disposed between the array substrate and the color filter substrate, a thin film transistor is disposed on the array substrate, and the color filter layer, the liquid crystal, the PS and the thin film transistor are disposed within the seal; and the recess is formed on the black matrix by a half tone mask process.
